(19) United States
(12) Patent Application Publication
(10) Pub. No.: US 2010/0304108 A1
(43) Pub. Date: Dec. 2, 2010

(54) STRETCHABLE NONWOVEN FABRIC, METHOD OF MANUFACTURING, AND PRODUCTS MADE THEREOF

(76) Inventors: Jayesh N. Doshi, (US); Mehul M. Vora, (US); Gary Ooten, (US)

Correspondence Address: ESPIN TECHNOLOGIES, INC., 7151 DISCOVERY DRIVE, CHATTANOOGA, TN, 37416, US

(21) Appl. No.: 12/474,586

(22) Filed: May 29, 2009

(51) Int. Cl. D04H 13/00; D01D 5/06; D01D 5/08; B32B 37/12; B29C 65/08; D05B 1/00

(52) U.S. Cl. 428/219; 442/328; 264/465; 264/176.1; 156/60; 156/73.1; 112/475.09

(57) ABSTRACT

The present invention relates generally to textile fabrics, and more particularly, to a stretchable, nonwoven nanofiber fabric which is impermeable to water but allows vapor transport, capable of conforming to body parts, and is particularly useful in high performance apparels and personal care products. The fabric is combined with different substrates to form a laminate. The fabric and its laminate can retain their dimensional integrity on repeated stretching, have relatively high air permeability while maintaining liquid repellency, and have high stretching recovery. Methods of preparing and applying the nanofiber fabric and its laminate are also provided.

### (1) FIELD OF THE INVENTION

The present invention relates generally to textile fabrics, and more particularly, to a stretchable, nonwoven nanofiber fabric which is impermeable to water but allows vapor transport, capable of conforming to body parts, and is particularly useful in high performance apparels and personal care products.

### (2) DESCRIPTION OF THE PRIOR ART

Stretchable fabric has seen increasing applications in articles used in wet conditions (rain, snow, etc.), in sports apparel (skiing, biking, hiking, etc.), in protective clothing (chemical and biological threat protection), and as wipes and other personal care products. In each instance, the article must protect the wearer from penetration of water or other fluids and microorganisms through the article while keeping the wearer comfortable by allowing perspiration to evaporate away from the body to the outside. In most instances, the article will be made to be reused, and therefore must maintain its functional attributes of protection, comfort, and conformability after multiple washes and repetitive stretching.

In articles of clothing where flexibility is important, composite laminates of the stretchable fabric with the above functional attributes are needed along with soft feel and good drapeability. Such composite laminates are increasingly used to make articles of form-fitting clothing such that the article allows for a closer fit without adversely affecting the comfort level. Examples of such articles requiring form-fitting properties include hand gloves, socks, stockings, ski wear, athletic wear, medical compresses, intimate apparel, and other similar articles. Also important is the directionality of stretching, the recovery of the material and the forces developed during recovery from stretching. These attributes are all important to determine the comfort of the form-fitting article, as well as ease of use during manufacturing.

U.S. Pat. No. 4,935,287 (Johnson et. al.) describes a variety of stretchable, waterproof laminated fabrics that also provide breathability as measured by their ability to pass water vapor. The invention covers stretchable laminate constructions based on an elastic fabric bonded on a substantially non-elastic film via a noncontinuous pattern of adhesive. A preferred embodiment of the invention uses a breathable waterproof non-elastic membrane to construct clean room and protective garment articles, limited in stretchability only in machine direction.

U.S. Pat. No. 5,244,716 (Thornton et. al.) describes a composite stretchable material comprising of a first film layer that is permeable to water vapor, but impermeable to liquid water. This layer is adhered to a second layer of stretchable water vapor permeable material, such that the second layer is corrugated, ruched, or puckered when under no stretching force. The preferred material of this invention also relies on a single microporous film layer for breathability and waterproofness. The microporous layer is susceptible to air permeability, and a loss of waterproofness due to clogging of the pores via contamination with low surface tension liquids like oils, perspiration, etc.

Similar stretchable laminates are also described in U.S. Pat. No. 4,761,324 (Rautenberg et. al.) where a layer of stretchable material is laminated using discontinuous adhesive segments onto a polymer film layer which is breathable, water-resistant and elastic in nature. The invention relies on a single layer of polymer film for waterproofness and breathability. However, if the film in non-porous, the polymer must be hydrophilic for adequate breathability. In that case, multiple washing will lead to swelling of the polymer film, whereby weakening the film significantly, thereby leading to decreased durability.

U.S. Pat. No. 5,36,551 (Dailey et. al.) describes a layered elastomeric composite fabric made of a microporous polymeric membrane, a water permeable polymer layer, and an elastomeric thermoplastic nonwoven material. The composite fabric provides barrier properties while being permeable to water vapor, and conforms to the wearer when used in apparel clothing. However, the inherent weakness of the nonwoven elastic material negates this fabric from being used in some applications. Also, in one embodiment, the invention uses a continuous layer of hydrophilic polyurethane which is susceptible to swelling and weakening in wet environments which could lead to durability issues where high humidity is encountered or when subject to multiple wash cycles.

U.S. Pat. No. 4,443,511 (Worden et. al.) describes a polytetrafluoroethylene based waterproof and breathable material for protective articles. Such an article can have a failure strain of 275% in machine direction, 145% in transverse direction, and a recovery of 39% after being stretched to 75% for 100 cycles. The polytetrafluoroethylene layer can also be bonded onto a stretchable fabric to form a durable laminate with a water vapor transmission rate exceeding 1000 g/m²·day. However, the material does not possess adequate stretch recovery properties for certain end uses.

The invention in U.S. Pat. No. 5,529,830 (Dutta et. al.) describes a stretchable layered fabric laminate which is air impermeable and waterproof while being permeable to water vapor. The stretchable fabric laminate consists of a stretchable composite material layer consisting of a hydrophobic protective layer of a porous polymeric material on each side of a hydrophilic water-vapor-permeable synthetic polymer layer. The composite material layer is laminated to at least one layer of stretchable fabric. The fabric laminate is capable of stretching at least 10% and recovering 80% of the amount stretched in both machine and transverse directions, and having a water vapor transmission rate of at least 2000 g/m²·day, and is useful for the manufacture of form-fitting articles of protective clothing and other end uses.

Other forms of stretchable fabrics are also discussed in U.S. Pat. No. 6,914,018 (Uitenbroek et. al.) which describes a biaxial elastic stretch, breathable laminate formed by combining a meltblown microfiber polymer film onto a spunbond nonwoven web stretchable in machine direction; in U.S. Pat. No. 5,187,952 (Zafiroglu) which describes a stretchable stitchbonded fabric stitched with elastic yarns to form at least two longitudinal regions of different stretchability; in U.S. Pat. No. 4,929,492 (Carey et. al.) which describes an elastically stretchable fabric comprising at least one elastically stretchable carrier web having substantially uniform stretch properties and a thin coherent coated layer of meltblown microfibers carried on at least one surface of the carrier web, leading to enhanced thermal insulation properties; and such others.

Nanofibers have been long established, and used in different applications as described in various patents, including applications that involve filtration (U.S. Pat. No. 6,743,273 (Chung et. al.)), sensors (U.S. Pat. No. 7,226,530 (Weiller et. al.)), making porous materials for enhanced catalysis (U.S. Pat. No. 5,800,706 (Fischer)), medical sealants (U.S. Pat. No. 6,495,127 (Wallace et. al.)), and such others. It is the aim of the present invention to a new, stretchable nonwoven nanofiber fabric having protection, comfort, and conformability.

### (3) SUMMARY OF THE INVENTION

It is the object of this invention to provide a stretchable, nonwoven nanofiber fabric.

It is another object of the invention to provide a stretchable, nonwoven nanofiber fabric that can be repeatedly stretched without loss of dimensional integrity.

It is another object of this invention to provide a stretchable, nonwoven nanofiber fabric capable of being formed into many woven and knitted fabric constitutions.

It is another object of this invention to provide a stretchable, nonwoven nanofiber fabric that will conform to the body part, such as hand and chest, without slipping.

It is another object of this invention to provide a stretchable, nonwoven nanofiber fabric such that the said nanofiber fabric has a hydrohead to basis weight ratio of greater than 1 mbar/gsm, and preferably greater than 5 mbar/gsm, whereby limiting the possibility of penetration by a liquid.

It is another object of this invention to provide a stretchable, nonwoven nanofiber fabric that has a basis weight between 0.01 gsm and 50 gsm, and preferably between 0.05 gsm and 20 gsm.

It is another object of this invention to provide a stretchable, nonwoven nanofiber fabric that has an air permittivity greater than 10 cfm, and preferably greater than 25 cfm, wherein the air permittivity is measured at 125 Pa.

It is another object of this invention to provide a stretchable, nonwoven nanofiber fabric that has nanofibers with diameter between 10 nm and 1000 nm, and preferably between 50 nm and 500 nm.

These and other objectives of the present invention are achieved in preferred embodiments disclosed below by providing a stretchable, nonwoven nanofiber fabric, either by itself or in combination with a substrate.

According to one preferred embodiment of the invention, the nanofibers can be made from elastomers like polyurethane, polyisoprene, poly(vinylidene fluoride), flouropolymers, and such others, and combinations of the same with other polymers.

According to yet another preferred embodiment of the invention, the nanofibers can be made by electrospinning method, meltblown, film defibrillation, and such others.

According to yet another preferred embodiment, the stretchable, nonwoven nanofiber fabric can be combined with a substrate of any material and type, such that the final laminate exhibits dimensional integrity after repeated stretching, and an air permittivity value greater than 0.2 cfm, and preferably greater than 2 cfm, wherein the air permittivity is measured at 125 Pa. The laminate made from the substrate and nanofiber fabric also behaves as a single fabric in performance, i.e. stretch and retract and remain in adherent contact under multiple stretches and washes. It is preferred that the stretchability of the substrate (measured via modulus and elastic strain) be within 10% of the nanofiber web for maintaining structural integrity. The laminate has a basis weight between 0.1 gsm and 150 gsm, and preferably between 0.5 gsm and 100 gsm, and associated hydrohead to basis weight ratios greater than 2 mbar/gsm, and preferably greater than 10 mbar/gsm.

The substrate can be made of meltblown microfibers, stretchable fabric materials like Lycra®, spunbond substrates of various polymers, and such others.

In the case of dissimilarity in stretchability of greater than 10% between the nanofiber fabric and the substrate, other bonding methods will be used to hold the layers together in the laminate, including but not restricted to adhesives, stitching, ultrasonic bonding, infrared heating and bonding, other physical and chemical bonding methods, and such others.

The stretchable, nonwoven nanofiber fabric and the laminate made of the said nanofiber fabric and a substrate can be used in various clothing applications including intimate apparel and sports garments, in various personal cleansing articles, personal care articles, personal care wipes such as baby wipes, facial wipes, body wipes, combinations thereof, and such others.

### (4) BRIEF DESCRIPTION OF VIEWS OF THE DRAWINGS

FIG. 1 shows a SEM (scanning electron microscope) micrograph of the top view of a stretchable, nonwoven nanofiber fabric to illustrate the nonwoven nature of the nanofiber mat, the individual nanofiber size and structure, and the pores between the nanofibers that provide for high air permittivity values.

FIG. 2 shows a SEM cross-sectional micrograph of a laminate where a stretchable, nonwoven nanofiber fabric is laminated onto a Lycra® substrate using adhesive as a bonding agent.

FIG. 3 shows a magnified view of FIG. 2.

FIG. 4 shows a perspective of a bra using parts composed of the stretchable, nonwoven nanofiber fabric in accordance to the present invention.

### (5) DETAILED DESCRIPTION

As explained more fully herein, the present invention related to a stretchable, nonwoven nanofiber fabric that can be produced from elastomers or similar polymers via electrospinning or other fiber manufacturing methods. The invention also relates to a laminate made of such nanofiber fabric and a substrate of any material and type, with or without a bonding agent in between. The said fabric and laminate have protective properties, breathability, comfort, and conformability.

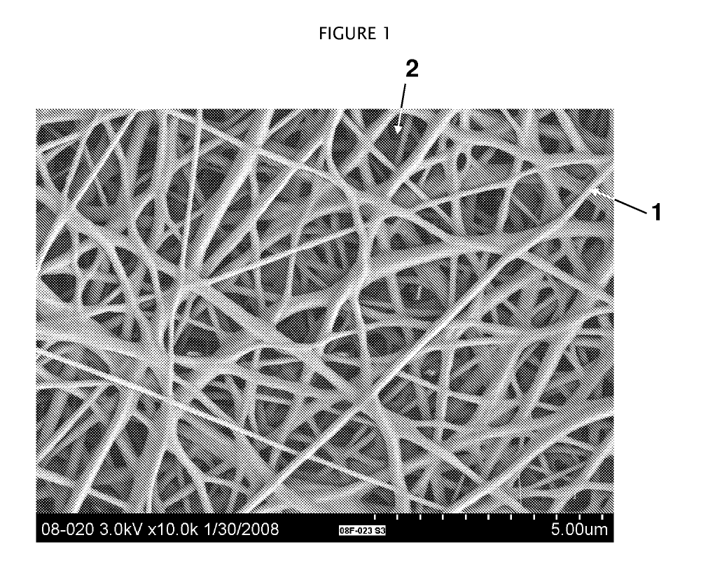

The stretchable, nonwoven nanofiber fabric is made of fibers ranging in diameter between 10 nm and 1000 nm, and preferably between 50 nm and 500 nm, as shown in FIG. 1. The nanofibers 1 are cylindrical with a smooth surface, with large inter-fiber pores 2 to provide relatively high air permittivity values, as shown in FIG. 1.

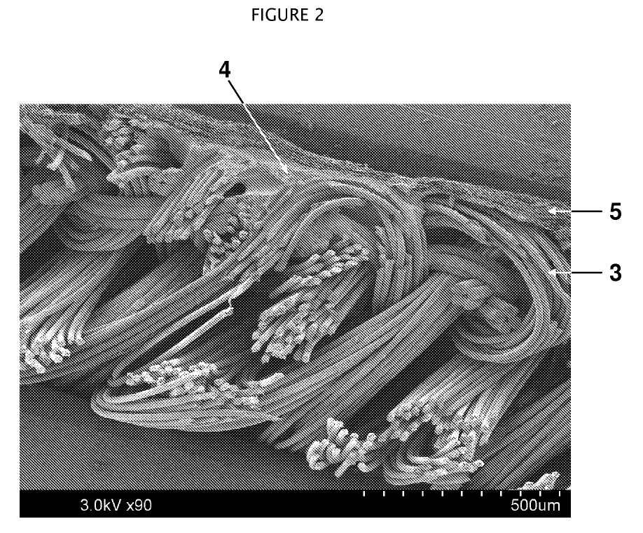

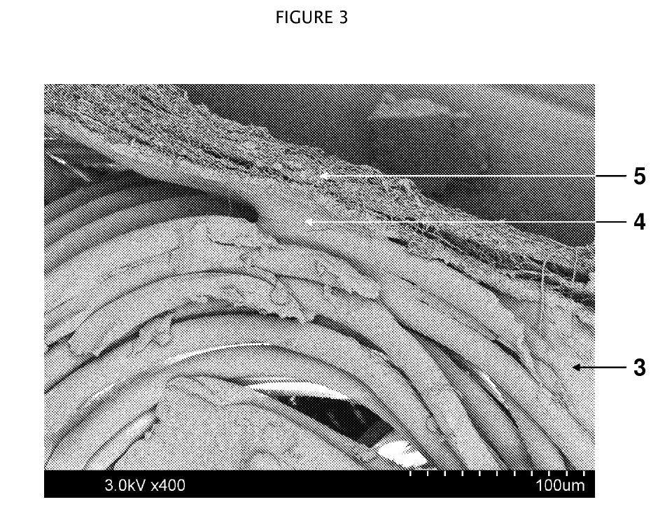

FIG. 2 and 3 show a laminate consisting of a supporting substrate layer 3 and a bonding agent 4 used to bond the stretchable, nonwoven nanofiber fabric layer 5 to the substrate layer.

The stretchable, nonwoven nanofiber fabric 5 is an intertwining network of nanofibers 1 made from a variety of polymers including elastomers like polyurethane and polyisoprene, poly(vinylidene fluoride), fluoropolymers, and other such polymers, their combinations and their blends with other polymers including copolymers.

The nanofiber 1 is made using any method from an available choice of nanofiber making methods, including but not restricted to electrospinning, meltblowing, film defibrilization, and others. In methods that require polymer solution, the solvent of choice can be made from the following group, including but again not restricted to N,N-dimethylformamide, tetrahydrofuran, dimethylacetamide, methanol, fluorinated solvents, their combinations thereof, and such others.

The substrate 3 as referred to in the current invention can come from a variety of available choices, including but not limited to substrates made from meltblown microfibers, stretchable fabric material like Lycra®, spunbond substrates of various polymers, and such others. The choice of substrate is also dictated by its stretchability relative to the stretchability of the nanofiber layer. It is preferred to use substrates having stretchability within 10% of the stretchability of the nanofiber layer. Another factor deciding the choice of the substrate is the final desired property and application of the laminate, e.g., a stretchable fabric like Lycra® will be used as the substrate for sporting apparels, whereas a meltblown polymeric microfiber substrate will be of choice for sanitary wipes.

In instances where the nanofiber and the substrate are not compatible, i.e. do not naturally adhere together, or instances where the stretchability difference is greater than 10% between the nanofiber layer and the substrate, external bonding methods will be used to facilitate bonding and ensure continuity in the laminate response. The bonding agent is applied such that it does not permeate into the nanofiber layer, whereby not altering the porosity of the nanofiber layer. The amount of bonding agent depends on the effectiveness of the bonding property and the bonding strength desired. The bonding agent could be an adhesive 4 as shown in FIGS. 2 and 3, or the bonding could be facilitated using any of the other available bonding methods, including but not restricted to stitching, ultrasonic bonding, infrared heating and bonding, other physical and chemical bonding methods, and such others.

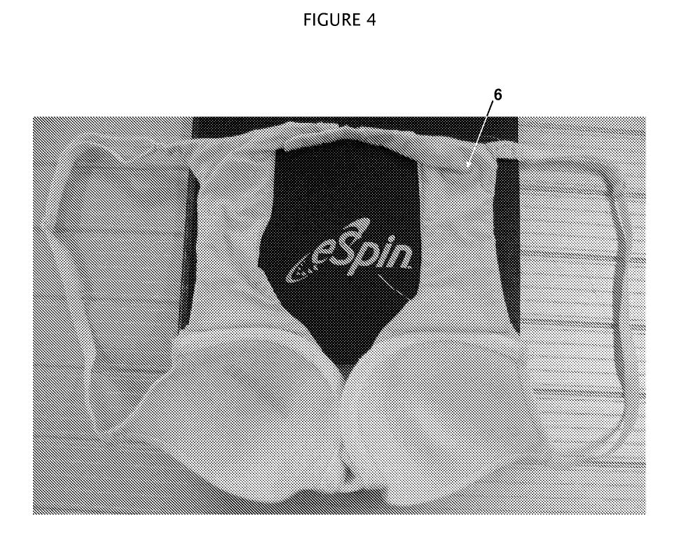

FIG. 4 illustrates a bra article indicated generally as 6 and composed of parts made from the stretchable, nonwoven nanofiber fabric in accordance to the present invention. In addition to the bra, the stretchable, nonwoven nanofiber fabric may be utilized for producing other articles of protective apparel, such as leggings, vests, and the like. The fabric may also be utilized in various articles for sports garments, personal cleansing articles, personal care articles, personal care wipes such as baby wipes, facial wipes, body wipes, combinations thereof, and many others.

The following examples illustrate several embodiments of the present invention. These examples should not be construed as limiting. The examples illustrate selection of the polymer and solvent for the nanofibers, the resulting fiber diameter, the operating conditions, and the resulting product characteristics.

### EXAMPLE 1

The object of the experiment outlined below was to develop a stretchable, nonwoven nanofiber fabric that can be laminated onto a Lycra® containing stretchable fabric to form a laminate which can then be used in a sports garment article.

A polyurethane (ESTANE X-1169 Thermoplastic PU) was mixed in a 70:30 mixture of N,N,-dimethylformamide and tetrahydrofuran, at a loading concentration of 16% on weight basis. The solution was adjusted with additives to have a conductivity of 107.4 mS/cm, viscosity of 599.3 cP, and total dissolved solids (TDS) of 37 mg/L.

Using a solution feed rate of 0.45 ml/min to the electrospinning equipment, the stretchable, nonwoven electrospun nanofiber fabric is made on a release liner substrate. The spinning occurs under the operating potential difference of 40 kV between the spinnerets and the collector plate separated by 2 inches. The fabric obtained has an average basis weight of 4.65 gsm.

A 85:15 Nylon-Lycra® fabric is coated with an adhesive layer designed in a dot matrix. The nanofiber fabric is then applied to this Nylon-Lycra® fabric, and the structure heat treated in a hot press to bond the nanofiber fabric to the Nylon-Lycra® fabric, thus obtaining a laminate as shown in FIG. 3.

The laminate thus obtained has nanofiber diameters ranging between 150 nm to 350 nm, and an average air permittivity value of 11.9 cfm (measured at 125 Pa). The laminate is also tested for its hydrohead value, which relative to the basis weight of the nanofiber layer comes out to be an average of 2.2 mbar/gsm.

### EXAMPLE 2

The object of the experiment outlined below was to develop a stretchable composite fabric obtained by electrospinning a stretchable, nonwoven nanofiber fabric onto a Lycra® containing stretchable fabric that has stretchability values within 10% of the nanofiber layer.

A polyurethane (ESTANE X-1169 Thermoplastic PU) was mixed in a 70:30 mixture of N,N,-dimethylformamide and tetrahydrofuran, at a loading concentration of 16% on weight basis. The solution was adjusted with additives to have a conductivity of 107.4 mS/cm, viscosity of 599.3 cP, and total dissolved solids (TDS) of 37 mg/L.

Using a solution feed rate of 0.45 ml/min to the electrospinning equipment, the stretchable, nonwoven electrospun nanofiber fabric was coated onto a stretchable Lycra® fabric. The spinning occurs under the operating potential difference of 40 kV between the spinnerets and the collector plate separated by 2 inches. The nanofiber layer has an average basis weight of 4.72 gsm.

The laminate thus obtained has nanofiber diameters ranging between 150 nm to 350 nm, and an average air permittivity value of 15.4 cfm (measured at 125 Pa). The laminate is also tested for its hydrohead value, which relative to the basis weight of the nanofiber layer comes out to be an average of 1.2 mbar/gsm.

It will therefore be readily understood by those persons skilled in the art that the present invention is susceptible of broad utility and application. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A stretchable, nonwoven fabric for use in high performance apparel comprised of nanofibers with sub-micrometer cross-sectional dimension, and capable of being formed into various nonwoven, woven, and knitted fabrics.

2. The fabric of claim 1 wherein the nanofibers can be electrospun, meltblown, or made by other nanofiber producing methods from elastomeric polymers like polyurethane, polyisoprene, poly(vinylidene fluoride), fluoropolymers, and others, their combinations thereof, and their blends with other polymers.

3. The fabric of claim 1 wherein the nanofibers have diameters between 10 nm and 1000 nm, and preferably between 50 nm and 500 nm.

4. The fabric of claim 1 wherein said fabric has a hydrohead to basis weight ratio of greater than about 1 mbar/gsm, and preferably greater than 5 mbar/gsm to facilitate resistance to liquid penetration.

5. The fabric of claim 1 wherein said fabric has a basis weight between 0.01 gsm and 50 gsm, and preferably between 0.05 gsm and 20 gsm.

6. The fabric of claim 1 wherein the said fabric has an air permittivity value greater than 10 cfm, and preferably greater than 25 cfm, when measured at 125 Pa.

7. A laminate made by laminating the stretchable, nonwoven nanofiber fabric of claim 1 onto a substrate layer such that the laminate exhibits dimensional integrity upon repeated stretching.

8. The laminate of claim 7 wherein the substrate and the nanofiber fabric have their stretchability within 10% of each other.

9. The laminate of claim 7 wherein the substrate and the nanofiber fabric have a difference of greater than 10% in between their stretchability.

10. The laminate of claim 7 wherein the substrate can be made of meltblown microfibers, stretchable fabric material like Lycra®, spunbond substrates of various polymers, and such others.

11. The laminate of claim 7 wherein the laminate has an air permittivity value greater than 0.2 cfm, and preferably greater than 2 cfm, when measured at 125 Pa.

12. The laminate of claim 9 wherein the substrate and the nanofiber mat are bonded to each other by various bonding methods, including but not restricted to adhesives, stitching, ultrasonic bonding, infrared heating and bonding, other physical and chemical bonding methods, and such others.

13. The fabric of claim 1, and the laminate of claims 7, 8, and 9 can conform to body parts, such as hands and chest, without slipping; and can be used in various clothing applications including intimate apparel and sports garments, in various personal cleansing articles, personal care articles, personal care wipes such as baby wipes, facial wipes, body wipes, combinations thereof, and many others.
